(19) United States
(12) Patent Application Publication
(10) Pub. No.: US 2007/0141433 A1
(43) Pub. Date: Jun. 21, 2007

(54) Single chamber solid oxide fuel cell with isolated electrolyte

(75) Inventors: Hyoung-Chul Kim, Seoul (KR); Jong-Ku Park, Gyeonggi-Do (KR); Hae-Weon Lee, Seoul (KR); Jong-Ho Lee, Seoul (KR); Joo-Sun Kim, Gyeonggi-Do (KR); Ji-Won Son, Seoul (KR); Sun-Hee Choi, Daegu (KR)

Correspondence Address: MORRISON & FOERSTER LLP, 1650 TYSONS BOULEVARD, SUITE 400, MCLEAN, VA, 22102, US

(73) Assignee: Korea Institute of Science and Technology, Seoul (KR)

(21) Appl. No.: 11/640,206

(22) Filed: Dec. 18, 2006

(30) Foreign Application Priority Data
Dec. 20, 2005 (KR) 10-2005-0126390

(51) Int. Cl. H01M 8/02; H01M 8/12; H01M 4/86

(52) U.S. Cl. 429/34; 429/30; 429/40

(57) ABSTRACT

Disclosed is a single chamber solid oxide fuel cell, in which an electrode is arranged on the same plane as an electrolyte and unit cells are integrated to one another. A high output density of the fuel cell is obtained, and a micro fuel cell for generating a high voltage and a high current is implemented by constructing the unit cells in series or in parallel.

### BACKGROUND OF THE INVENTION

1. Field of the Invention

The present invention relates to a single chamber solid oxide fuel cell (SC-SOFC) for supplying fuel gas and oxidation gas, and more particularly, to an integrated single chamber solid oxide fuel cell used as a power source of a micro-miniaturized precision component such as a portable phone or a notebook and a portable information communication device.

2. Description of the Background Art

A single chamber solid oxide fuel cell (SC-SOFC) is operated as follows. A cathode and an anode are alternately arranged on one surface of an electrolyte, or the cathode and the anode are respectively arranged at both surfaces of the electrolyte. Fuel gas, carbon hydrogen and oxidation gas, air are mixed to each other thus to be injected into a fuel cell system. A reaction of the fuel gas is accelerated since metal elements such as Ni, Pd, Ru, etc. are included in a ceria-based oxide to which rare earth elements are doped. In the fuel cell, electricity is generated by an oxidation reaction of hydrogen and carbon monoxide and a deoxidation reaction of oxygen.

The cathode and the anode of the SO-SOFC have to be formed of an excellent material for a selective reaction with mixed gas. Also, a low temperature ion conductivity of an electrolyte material has to be obtained for a high output density in a low temperature, and thus a polarization resistance for moving oxygen has to be small.

At first, the SOFC started to develop for a middle/large developing system due to primary characteristics thereof.

A portable electronic device such as a portable phone or a notebook requires a power corresponding to 0.5 to 20 w. Therefore, technique for a small fuel cell to be used as a power source of the portable electronic device has to be differentiated from technique for a large fuel cell for generating power corresponding to 10 to 250 kw. The conventional technique for a large fuel cell is not optimum when compared with the technique for a small fuel cell. In the technique for a small fuel cell, a design that can be commercially utilized is not disclosed.

### BRIEF DESCRIPTION OF THE INVENTION

Therefore, an object of the present invention is to provide a single chamber solid oxide fuel cell having an electrode system of a micro-meter or a nano-meter on the same plane as an electrolyte.

Another object of the present invention is to provide a micro-miniaturized output system having an excellent mobility and generating a high voltage and a high output by integrating unit cells thereof.

To achieve these and other advantages and in accordance with the purpose of the present invention, as embodied and broadly described herein, there is provided an electrolyte patterned as an isolated form, an electrolyte having a quasi-isolated form to perform an electrochemical function, and a current collector design having various forms for connecting a micro-miniaturized electrode system in series or in parallel.

The present invention provides a single chamber solid oxide fuel cell comprising: an electrolyte patterned on a substrate as an isolated form; an electrode formed on the same plane as the electrolyte to be in contact with the electrolyte; and a current collector arranged on the substrate and connected to the electrode.

The present invention provides a single chamber solid oxide fuel cell formed as a plurality of unit cells are integrated to one another, the unit cell comprising: an electrolyte patterned on a substrate as an isolated form; an electrode formed on the same plane as the electrolyte to be in contact with the electrolyte; and a current collector arranged on the substrate and connected to the electrode, in which the current collector connects the unit cells in parallel.

The present invention provides a single chamber solid oxide fuel cell formed as a plurality of unit cells are integrated to one another, the unit cell comprising: an electrolyte patterned on a substrate as an isolated form; an electrode formed on the same plane as the electrolyte to be in contact with the electrolyte; and a current collector arranged on the substrate and connected to the electrode, in which the current collector connects the unit cells in series.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIGS. 1 to 5 are sectional views showing a single chamber solid oxide fuel cell (SC-SOFC) with an isolated electrolyte according to the present invention;

FIGS. 6 to 8 are sectional and planar views showing a current collector having various shapes that can be applied to the SC-SOFC according to the present invention;

FIGS. 9 and 10 are planar and A-A′ sectional views showing a high current power device in which unit cells that can be fabricated by the SC-SOFC of the present invention are arranged in parallel;

FIGS. 11 and 12 are planar and B-B′ sectional views showing a high voltage power device in which the unit cells that can be fabricated by the SC-SOFC of the present invention are arranged in series;

FIG. 13 is a graph showing two output densities of the SC-SOFC according to the present invention;

FIG. 14 is a photo showing fuel cells integrated in series and in parallel according to the present invention; and

FIG. 15 is a graph showing an output characteristic of the integrated fuel cell according to the present invention.

### DETAILED DESCRIPTION OF THE INVENTION

Reference will now be made in detail to the preferred embodiments of the present invention, examples of which are illustrated in the accompanying drawings.

As a substrate of the present invention, one of Si, SiO₂, Si₃N₄, Al₂O₃, MgO, TiO₂, ZrO₂, and each of the above materials with a dopant can be used.

When a semiconductor material such as a silicon wafer, etc. is used as the substrate, one of Si, SiO₂, Si₃N₄, Al₂O₃, MgO, TiO₂, ZrO₂, and each of the above materials with a dopant can be further comprised on the substrate as an insulating and thermal expansion buffer layer.

An electrolyte can be directly used as the substrate, and the electrolyte can be implemented as a quasi-isolated form by forming grooves having a square shape, a triangle shape, etc. with a certain gap.

The electrode can be variously implemented so as to come in contact with a lateral wall of the electrolyte, an upper end of the electrolyte, or an end of the electrolyte. The various implementation of the electrode can cause a different property of the fuel cell.

The current collector can be arranged so as to come in contact with a lateral wall of the electrode and the electrolyte, or so as to come in contact with an upper surface and a lateral wall of the electrode, or so as to come in contact with an end of the electrode. The various implementation of the current collector can cause a different property of the fuel cell, and the current collector can be applied to connect the unit cells in series or in parallel.

An isolated electrolyte system having various forms and a design of a specific electrolyte corresponding to the system according to the present invention are shown in FIGS. 1 to 5.

As shown in FIG. 1, an isolated electrolyte system of the present invention can be implemented by patterning a plurality of electrolytes 25 on a substrate 10 as an isolated form, and by forming electrodes 20 and 22 at a lateral wall and an upper end of each electrolyte. As shown in FIG. 2, it is also possible that the plural electrolytes 25 are patterned on the substrate 10 as an isolated form and the electrodes 20 and 22 are formed only at the upper end of each electrolyte.

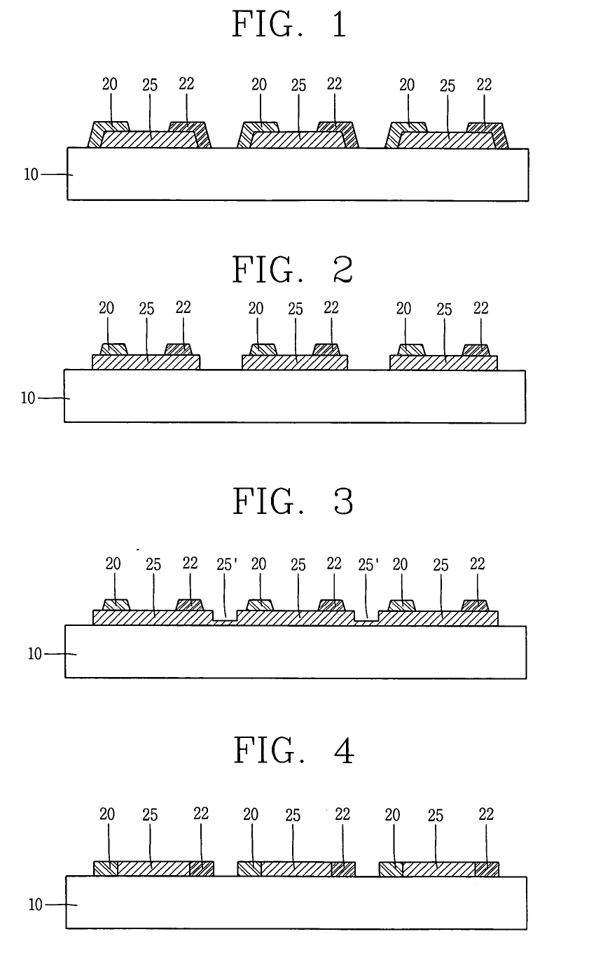

As shown in FIG. 3, the electrodes can be formed as a semi-isolated form rather than the isolated form by forming grooves 25′ having a triangle shape or a square shape at the consecutive electrolytes 25.

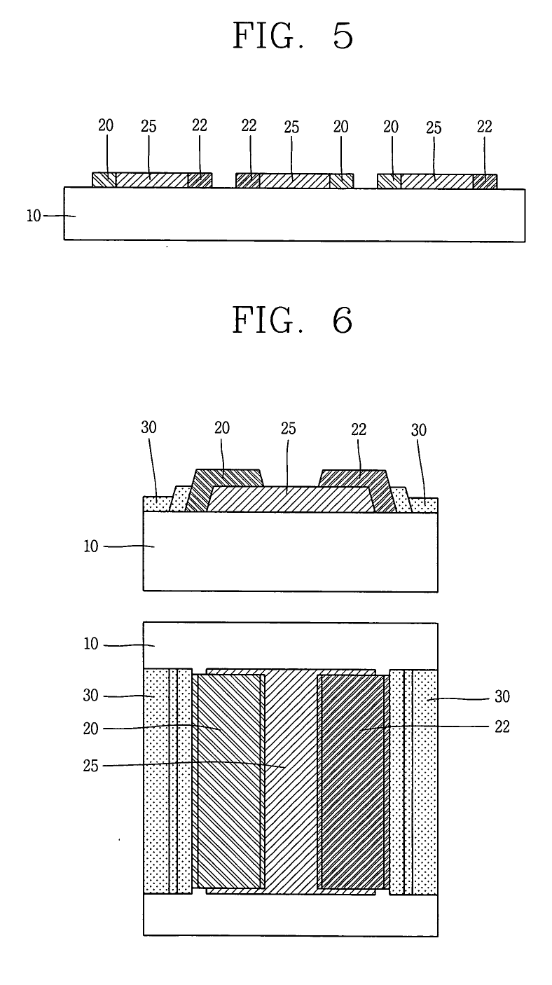

As shown in FIG. 4, the plural electrolytes 25 are patterned on the substrate 10 as an isolated form, and a cathode 22 and an anode 20 are formed at both lateral walls of each electrolyte. As shown in FIG. 5, it is also possible to pattern the plural electrolytes 25 on the substrate 10 and then to arrange the cathodes 22 and the anodes 20 so that the cathodes 22 can face to each other and the anodes 20 can face to each other.

The electrolytes and the electrodes can be formed by using a thin film forming technique used at a semiconductor process, etc. The electrolytes or the electrodes can be formed to have a micro-size less than a micrometer.

FIGS. 6 to 8 show each form of a current collector according to the present invention. The current collector connects the unit cells to one another in series or in parallel, and is formed of precious metal such as porous or dense Au, Pt, Ag, Pd, etc. or metal having an oxidation resistance, etc.

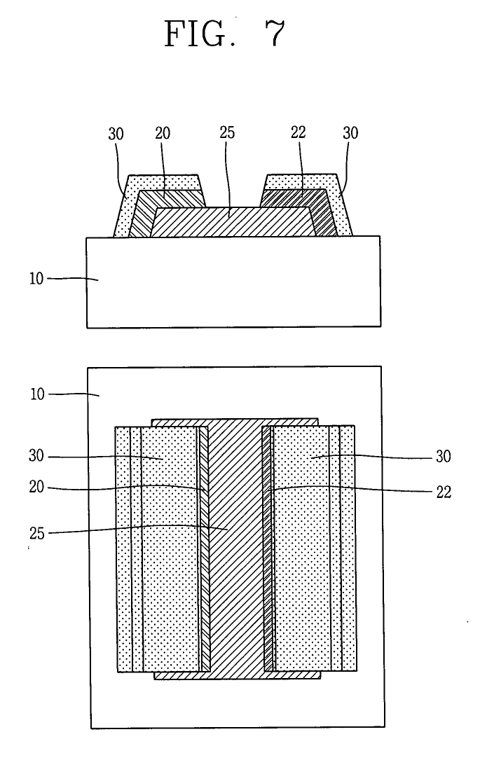

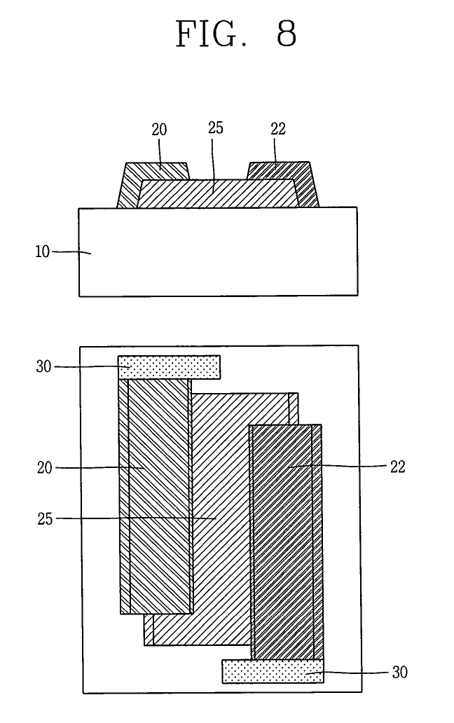

More concretely, as shown in FIG. 6, a current collector 30 is formed to come in contact with each lateral wall of the electrodes 20 and 22. As shown in FIG. 7, the current collector 30 is formed to cover most of parts of the electrodes 20 and 22. Referring to FIG. 8, the current collector 30 is formed to connect only each end of the electrodes 20 and 22.

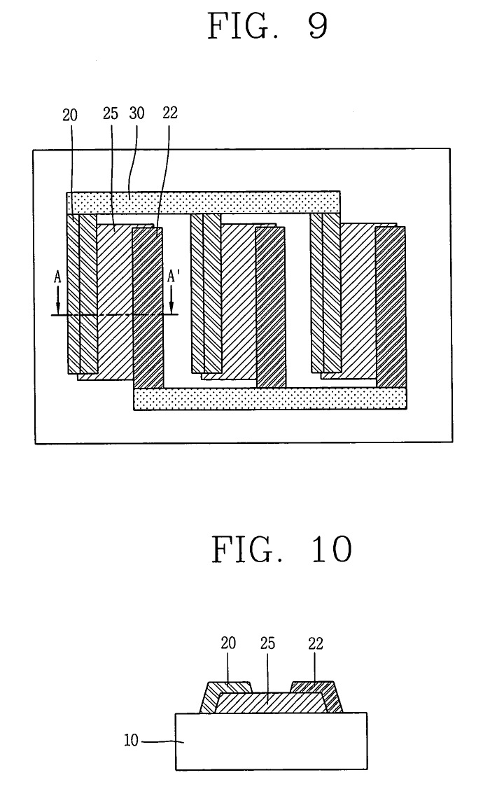

FIGS. 9 and 10 show a state that the SC-SOFCs having isolated electrolytes are connected to one another in parallel by a current collector according to the present invention.

The cathodes 20 of each unit cell are connected to one another by the current collector 30, and the anodes 22 are connected to one another by the current collector 30. As the result, the unit cells can be connected to one another in parallel, so that an integrated production suitable for the system requiring a high current is implemented.

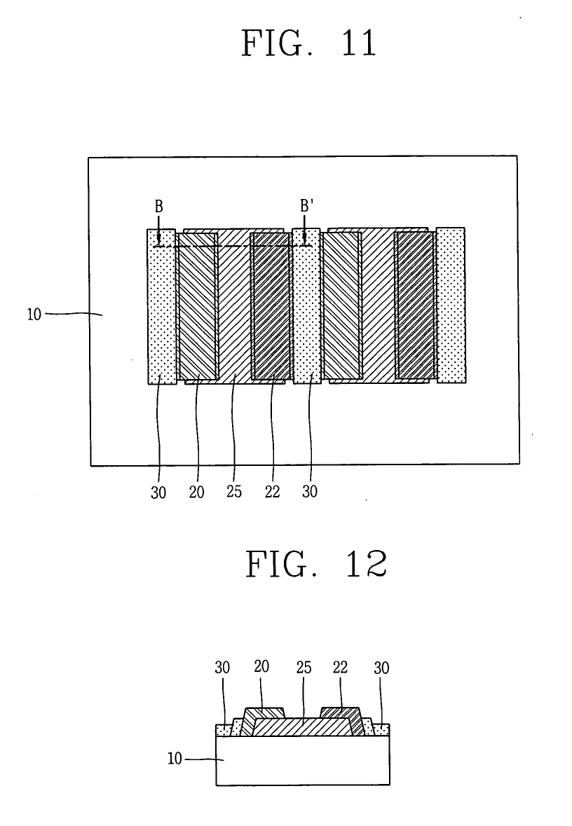

FIGS. 11 and 12 show a state that the SC-SOFCs having isolated electrolytes are connected to one another in series by a current collector according to the present invention. The cathodes 20 and the anodes 22 of the unit cells are connected to one another by the current collector 30, thereby connecting the unit cells to one another in series. As the result, an integrated production suitable for the system requiring a high current is implemented.

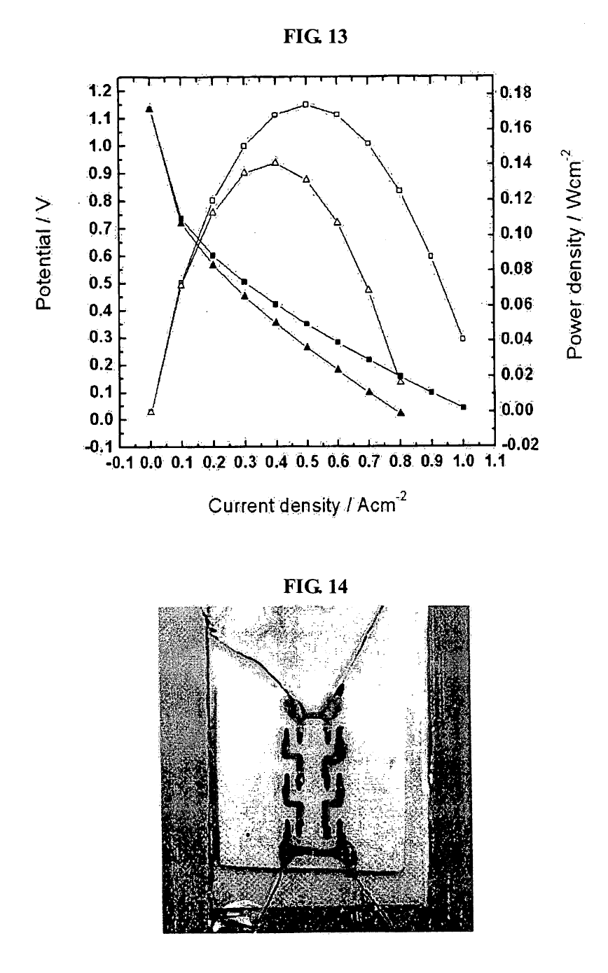

FIG. 13 is a graph showing an output density of the unit fuel cell of FIG. 2 in which an electrode is formed only at an upper surface of the isolated electrolyte and the unit fuel cell of FIG. 5 in which an electrode is formed only at a lateral surface of the isolated electrolyte by a computational simulation. Referring to FIG. 13, the white triangle and the white square denote an output density of the fuel cell of FIG. 2 and an output density of the fuel cell of FIG. 5, respectively. Also, the black triangle and the black square denote a potential value of the fuel cell of FIG. 2 and a potential value of the fuel cell of FIG. 5, respectively.

An ohmic loss generated from the electrolyte is reduced according to the electrode arrangement. The electrode of FIG. 5 shows an increased output density of approximately 43 mW/cm² at a current density of 0.5 A/cm². The output density was obtained by a computational simulation based on a finite element method, the temperature was 500° C., and the pressure was 1 atm. The electrolyte is formed of GDC (Gd_{0.1}Ce_{0.9}O_{1.95}), the cathode is formed of SSC (Sm_{0.5}Sr_{0.5}CoO₃), and the anode is formed of Ni-GDC. Mechanical, electrical, and chemical properties of the above materials are based on values reported by each document. As input gas, mixture gas of hydrogen, nitrogen and oxygen corresponding to 0.3 m/s was used.

FIG. 14 is a photo showing fuel cells integrated in series or in parallel by forming the electrode only at an upper surface of the isolated electrolyte (refer to FIG. 2) and by connecting the current collector only to the end of the electrode (refer to FIG. 8) according to the present invention.

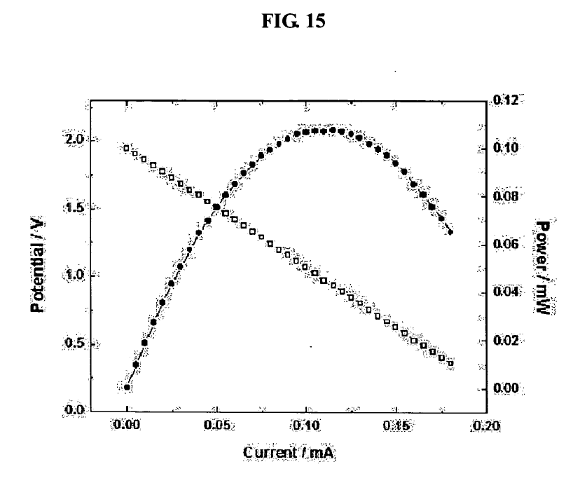

FIG. 15 is a graph showing an output characteristic of the integrated fuel cell of FIG. 14 by an experiment.

First, a substrate formed of 99.9% of Al₂O₃ to be used as an insulating substrate was washed, and a screen printing was performed four times by using a paste formed of 8 mol % Y₂O₃—ZrO₂ (Yittria Stabilized Zirconia; YSZ). As the result, an isolated electrolyte was formed on the alumina substrate.

A paste for an anode was robo-dispensed on the patterned isolated electrolyte thereby to form an electrode. The robo-dispensing technique is a method for forming a minute electrode pattern by discharging a paste having a proper viscosity through a nozzle of which position can be controlled. Then, the formed electrode was dried in order to remove a volatile solvent therefrom, and then a sintering process was performed thereby to obtain a porous anode electrode. The robo-dispensing process was performed near the sintered anode electrode in the same manner as the aforementioned method, thereby forming a cathode electrode.

NiO-GDC to which little amount of Pd is added was used as the anode material, and a mixture material between La_{0.8}Sr_{0.2}MnO₃ and YSZ was used as the cathode material. The anode was sintered for one hour at a temperature of 1350° C., and the cathode was sintered for one hour at a temperature of 1200° C.

FIG. 14 shows completed SC-SOFCs having isolated electrolytes according to the present invention. One electrode system is implemented as three unit fuel cells are connected to one another in series, and the two electrode systems are connected to each other in parallel thereby to constitute the entire cell. The completed SC-SOFCs were integrated with one another by applying Au paste to each end of the anode and the cathode. Then, the completed SC-SOFCs were connected to a measuring system by an Au wire. An open current voltage (OCV) and an output voltage of the fuel cell were measured by using a voltmeter, thereby obtaining a current-voltage output characteristic of the fuel cell. 96 sccm of CH₄ was used as fuel gas, 80 sccm of air was used as oxidation gas, and 100 sccm of N₂ was used as balance gas. As shown in FIG. 15, the integrated SC-SOFCs with isolated electrolytes according to the present invention show an open current voltage of approximately 1.95V and an output density of approximately 0.115 mW at a temperature of 900° C. Accordingly, the unit cells are connected to one another in series and in parallel by using the isolated electrolyte, thereby implementing a high-integrated power device system.

As aforementioned, the fuel cell of the present invention has a micro-size when compared with the conventional solid oxide fuel cell. The high-integrated micro power device of the present invention has an excellent output density and efficiency. Also, the present invention can be variously applied to other technique fields. Furthermore, the micro-sized fuel cell of the present invention serves as a mobile next generation small power supply device and implements a high integration and a micro-size.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A single chamber solid oxide fuel cell, comprising:
an electrolyte patterned on a substrate as an isolated form;
an electrode arranged on the same plane as the electrolyte to be in contact with the electrolyte; and
a current collector arranged on the substrate and connected to the electrode.

2. The fuel cell of claim 1, wherein the substrate is formed of one of SiO₂, Si₃N₄, Al₂O₃, MgO, TiO₂, ZrO₂, and each of the materials with a dopant.

3. The fuel cell of claim 1, wherein the substrate is a silicon wafer.

4. The fuel cell of claim 3, wherein one of SiO₂, Si₃N₄, Al₂O₃, MgO, TiO₂, ZrO₂, and each of the materials with a dopant is formed on the substrate as an insulating and thermal expansion buffer layer.

5. The fuel cell of claim 1, wherein the electrolyte is directly used as the substrate, and the electrolyte is implemented as an isolated form by forming grooves having a square shape, a triangle shape, etc. with a certain gap.

6. The fuel cell of claim 1, wherein the electrode comes in contact with only lateral walls of the electrolyte.

7. The fuel cell of claim 1, wherein the electrode comes in contact with only an upper end of the electrolyte.

8. The fuel cell of claim 1, wherein the electrode comes in contact with only an end of the electrolyte.

9. The fuel cell of claim 8, wherein the electrodes are arranged so that same electrodes can face to each other.

10. The fuel cell of claim 8, wherein the electrodes are arranged so that different electrodes can face to each other.

11. The fuel cell of claim 1, wherein the current collector comes in contact with only a lateral wall of the electrode.

12. The fuel cell of claim 1, wherein the current collector comes in contact with only an upper surface and a lateral wall of the electrode.

13. The fuel cell of claim 1, wherein the current collector comes in contact with only an end of the electrode.

14. The fuel cell of claim 1, wherein the current collector is formed of precious metal such as Au, Pt, Ag, etc. or metal having an oxidation resistance, and has a porous or dense form.

15. A single chamber solid oxide fuel cell formed as a plurality of unit cells are integrated to one another, the unit cell comprising:
an electrolyte patterned on a substrate as an isolated form;
an electrode formed on the same plane as the electrolyte to be in contact with the electrolyte; and
a current collector arranged on the substrate and connected to the electrode, in which the current collector connects the unit cells in parallel.

16. A single chamber solid oxide fuel cell formed as a plurality of unit cells are integrated to one another, the unit cell comprising:
an electrolyte patterned on a substrate as an isolated form;
an electrode formed on the same plane as the electrolyte to be in contact with the electrolyte; and
a current collector arranged on the substrate and connected to the electrode, in which the current collector connects the unit cells in series.
